(19) United States
(12) Patent Application Publication
(10) Pub. No.: US 2006/0277367 A1
(43) Pub. Date: Dec. 7, 2006

(54) Speculative writeback for read destructive memory

(76) Inventor: Robert W. Faber, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/146,948

(22) Filed: Jun. 7, 2005

(51) Int. Cl. G06F 12/00; G06F 13/28

(52) U.S. Cl. 711/137; 711/143

(57) ABSTRACT

Briefly, a speculative write back to a memory location is performed when reading a memory word from a destructive read memory. The speculative write back is performed prior to checking the memory word read for errors. Upon detecting an error in the memory word, the memory location is erased and a corrective write back is performed.

### BACKGROUND

Description of the Related Art

The use of a cache in a computer reduces memory access time and increases the overall speed of a device. Typically, a cache is an area of memory which serves as a temporary storage area for a device and has a shorter access time than the device it is caching. Data frequently accessed by the processor remain in the cache after an initial access. Subsequent accesses to the same data may be made to the cache.

Two types of caching are commonly used, memory caching and disk caching. A memory cache, sometimes known as cache store, is typically a high-speed memory device such as a static random access memory (SRAM). Memory caching is effective because most programs access the same data or instructions repeatedly.

Disk caching works under the same principle as memory caching but uses a conventional memory device such as a dynamic random access memory (DRAM). The most recently accessed data from the disk is stored in the disk cache. When a program needs to access the data from the disk, the disk cache is first checked to see if the data is in the disk cache. Disk caching can significantly improve the performance of applications because accessing a byte of data in RAM can be thousands of times faster than accessing a byte on a disk.

Both the SRAM and DRAM are volatile memories. Therefore, in systems using a volatile memory as the cache memory, data stored in the cache memory would be lost when the power is shut off to the system. Accordingly, some devices may utilize non-volatile memory.

Certain non-volatile memories, such as polymer memory, are destructive read memories. Data stored in a memory location of destructive read memories are erased by the process of reading the memory location. In normal operation it is necessary to perform a write back after every read to preserve data. Some memories have a raw soft error rate and include an error correction code (ECC) with data. Upon reading data, the ECC is checked and data is corrected as needed. For destructive read memories with a soft error rate, the read process is long due to the need to check and correct data prior to performing a write back.

### BRIEF DESCRIPTION OF THE DRAWINGS

The present invention may be better understood, and its numerous features and advantages made apparent to those skilled in the art by referencing the accompanying drawings.

FIG. 1 illustrates portions of a destructive read memory device according to an embodiment of the present invention.

FIG. 2 illustrates a destructive read memory access with speculative write back according to an embodiment of the present invention.

FIG. 3 illustrates a destructive read memory access flow according to an embodiment of the present invention.

FIG. 4 illustrates a system 400 according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As disclosed herein, a “cache” refers to a temporary storage area and can be either a memory cache or a disk cache. The term “system boot” refers to initialization of a computer both when the power is first turned on, known as cold booting, and when a computer is restarted, known as warm booting. The term “computer readable medium” includes, but is not limited to portable or fixed storage devices, optical storage devices, and any other memory devices capable of storing computer instructions and/or data. The term “computer instructions” are software or firmware including data, codes, and programs that can be read and/or executed to perform certain tasks.

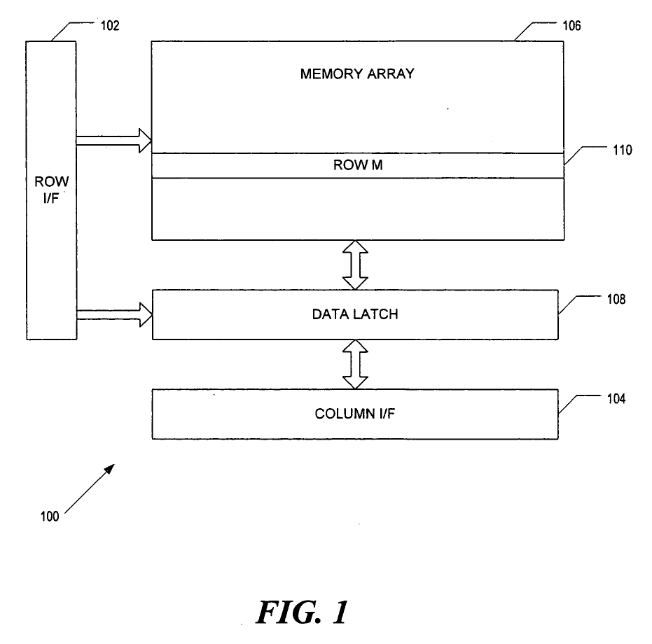

FIG. 1 illustrates portions of a destructive read memory device according to an embodiment of the present invention. A destructive read memory device 100 may include a row interface 102, a column interface 104, a memory array 106, and a data latch 108. Data latch 108 holds data as it is written to a memory array location and receives data when it is read from a memory location. The width of the data path between the memory array and the data latch may equal to the block size. In one embodiment of the present invention, memory array 106 is a 64K by 4K array and data latch 108 is 4K bytes wide.

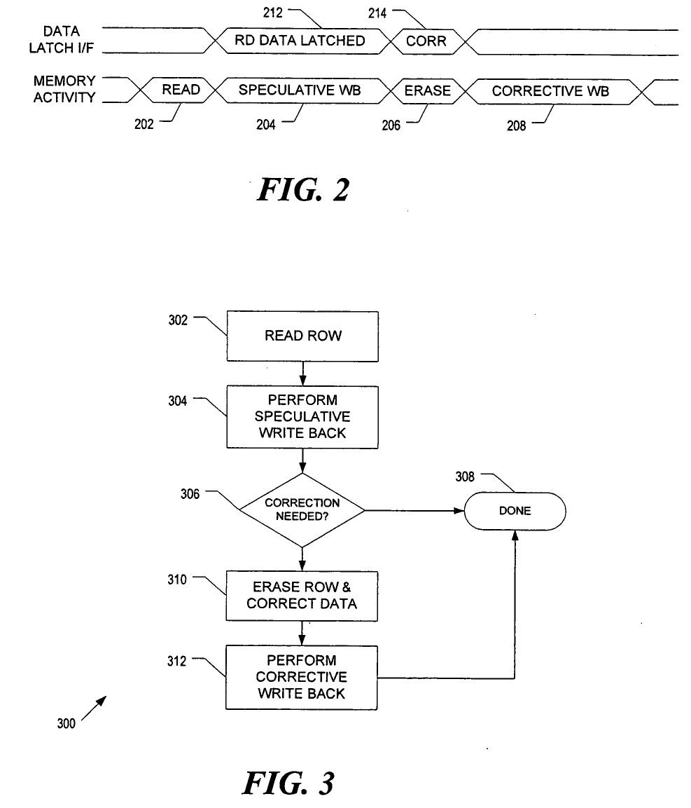

According to an embodiment of the present invention, row interface 102 and column interface 104 interact to read a row of data, for example row M 110 from memory array 106. The read data is latched by data latch 108. According to an embodiment of the present invention, the read data is speculatively written back to row 110 in memory array 106. The write back is a speculative write back because it is made prior to error checking and on the speculation that no corrections are required. During the speculative write back, data checking and correction (if needed) is performed. Data checking and correction may be performed in software or alternatively by circuitry within column interface 104 or row interface 102. The invention is not limited in this respect. If correction is needed, row M 110 is erased and the corrected data written back. These accesses are illustrated in FIG. 2. The memory activity includes a read 202, then a speculative write back 204 of the read data, and if data correction is needed, an erase 206 followed by a corrective write back 208. The data latch contains read data 212 after read 202 and during speculative write back 204 and then corrected data 214 during erase 206.

FIG. 3 illustrates a destructive read memory access flow according to an embodiment of the present invention. A read is performed, block 302. A speculative write back occurs, block 304. A determination is made whether the data needs correcting, block 306. If not, the read process is complete, block 308. If the data needs correcting, the memory location read is erased and data is corrected, block 310. Erasing and correcting may occur sequentially or overlap. The invention is not limited in this respect. A corrective write back is performed with corrected data, block 312 and the read process is complete, block 308.

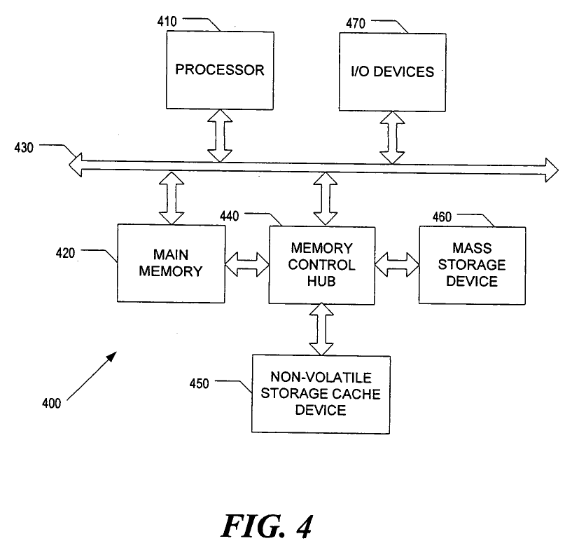

FIG. 4 illustrates a system 400 according to an embodiment of the present invention. System 400 includes a processor 410 coupled to a main memory 420 by a bus 430. Main memory 410 may include a random-access-memory (RAM) and be coupled to a memory control hub 440. Memory control hub 440 may also be coupled to bus 430, to a nonvolatile storage cache device 450 and to a mass storage device 460. Mass storage device 460 may be a hard disk drive, a floppy disk drive, a compact disc (CD) drive, a Flash memory (NAND and NOR types, including multiple bits per cell), a ferroelectric RAM (FRAM), or a polymer FRAM (PFRAM) or any other existing or future memory device for mass storage of information. Memory control hub 440 controls the operations of main memory 420, non-volatile storage cache device 450 and mass storage device 460. Finally, a number of input/output devices 470 such as a keyboard, mouse and/or display may be coupled to bus 430.

Although system 400 is illustrated as a system with a single processor, other embodiments may be implemented with multiple processors, in which additional processors may be coupled to the bus 430. In such cases, each additional processor may share the non-volatile storage cache device 450 and main memory 420 for writing data and/or instructions to and reading data and/or instructions from the same. Also, although non-volatile storage cache device 450 is shown external to mass storage device 460, in other embodiments non-volatile storage cache device 450 may be internally implemented into any non-volatile media in a system. For example, in one embodiment, non-volatile storage cache device 450 may be a portion of mass storage device 460.

Because retrieving data from mass storage device 460 can be slow, caching may be achieved by storing data recently accessed from the mass storage device 460 in a non-volatile storage media such as non-volatile storage cache device 450. The next time the data is needed, it may be available in non-volatile storage cache device 450, thereby avoiding a time-consuming search and fetch in mass storage device 460. Non-volatile storage cache device 450 may also be used for writing. In particular, data may be written to non-volatile storage cache device 450 at high speed and then stored until the data is written to mass storage device 460, for example, during idle machine cycles or idle cycles in a mass storage subsystem.

According to one embodiment of the present invention, memory control hub 440 may control the processes of flow 300 including initiating a read, a speculative write back, error checking and correcting, erasing and corrective write backs. In another embodiment of the present invention, one or more of these processes are controlled within non-volatile storage cache device 450. The present invention is not limited in this respect.

By performing a speculative write back prior to checking the data for errors, only those memory operations where the data has errors are long. If the error rate for memory is low, performance can be significantly improved because the average cycle time is shorter. Speculative write back also reduces the amount of time that the memory system is exposed to unexpected power failure. When the system has a requirement to have sufficient energy reserve to complete the write back, delaying the write back for error checking and correction widens the window, increasing the amount of energy storage required.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method comprising:
reading a memory word from a memory location; and
performing a speculative write back to the memory location.

2. The method as recited in claim 1, wherein performing the speculative write back comprises writing the memory word prior to performing error checking on the memory word.

3. The method as recited in claim 1, further comprising:
performing error checking on the memory word.

4. The method as recited in claim 3, wherein performing error checking on the memory word comprises checking an error correction code (ECC).

5. The method as recited in claim 3, further comprising:
if an error is detected in the memory word, erasing the memory location and performing a corrective write back to the memory location.

6. The method as recited in claim 5, wherein erasing the memory location comprises reading the memory location.

7. The method as recited in claim 5, further comprising correcting the memory word prior to performing the corrective write back if the error is detected in the memory word.

8. The method as recited in claim 7, wherein the correcting and the erasing occur sequentially.

9. The method as recited in claim 7, wherein the correcting and the erasing overlap in time.

10. The method as recited in claim 3, wherein if an error is not detected, a corrective write back is not performed.

11. An apparatus comprising:
a data latch to latch a memory word read from a memory location; and
interface circuitry to read the memory word from the memory location and to perform a speculative write back to the memory location.

12. The apparatus as recited in claim 1 1, wherein to perform the speculative write back, the interface circuitry further to write the memory word prior to performing error checking on the memory word.

13. The apparatus as recited in claim 11, the interface circuitry further to perform error checking on the memory word.

14. The apparatus as recited in claim 13, wherein to perform error checking on the memory word, the interface circuitry further to check an error correction code (ECC).

15. The apparatus as recited in claim 13, the interface circuitry further to erase the memory location and perform a corrective write back to the memory location upon detecting an error in the memory word.

16. The apparatus as recited in claim 15, wherein to erase the memory location the interface circuitry further to read the memory location.

17. The apparatus as recited in claim 15, the interface circuitry further to correct the memory word prior to performing the corrective write back upon detecting the error in the memory word.

18. A program loaded in a computer readable medium comprising:
a first group of instructions to cause a memory system to read a memory word from a memory location; and
a second group of instructions to cause the memory system to perform a speculative write back to the memory location.

19. The program as recited in claim 18, wherein the second group of instructions comprise a third group of instructions to cause the memory system to write the memory word prior to performing error checking on the memory word.

20. The program as recited in claim 18, further comprising:
a fourth group of instructions to cause the memory system to perform error checking on the memory word.

21. The program as recited in claim 20, wherein to perform error checking on the memory word, the fourth group of instructions cause the memory system to check an error correction code (ECC).

22. The program as recited in claim 20, further comprising:
a fifth group of instructions to cause the memory system to erase the memory location and perform a corrective write back to the memory location upon detecting an error in the memory word.

23. The program as recited in claim 22, wherein to erase the memory location, the fifth group of instructions cause the memory system to read the memory location.

24. The program as recited in claim 22, further comprising a sixth group of instructions to cause the memory system to correct the memory word prior to performing the corrective write back upon detecting the error in the memory word.

25. A system comprising:
a non-volatile storage media; and
a data latch to latch a memory word read from a memory location in the non-volatile storage media; and
a memory controller to read the memory word from the memory location and to perform a speculative write back to the memory location.

26. The system as recited in claim 25, wherein to perform the speculative write back, the memory controller further to write the memory word prior to performing error checking on the memory word.

27. The system as recited in claim 25, the memory controller further to perform error checking on the memory word.

28. The system as recited in claim 27, wherein to perform error checking on the memory word, the memory controller further to check an error correction code (ECC).

29. The system as recited in claim 27, the memory controller further to erase the memory location and perform a corrective write back to the memory location upon detecting an error in the memory word.

30. The system as recited in claim 29, wherein to erase the memory location the memory controller further to read the memory location.

31. The system as recited in claim 29, the memory controller further to correct the memory word prior to performing the corrective write back upon detecting the error in the memory word.
